(19) United States
(12) Patent Application Publication
(10) Pub. No.: US 2024/0364560 A1
(43) Pub. Date: Oct. 31, 2024

(54) CROSS-MODAL ASSOCIATION BETWEEN WEARABLE AND STRUCTURAL VIBRATION SIGNAL SEGMENTS FOR INDOOR OCCUPANT SENSING

(71) Applicant: THE REGENTS OF THE UNIVERSITY OF CALIFORNIA, Oakland, CA (US)

(72) Inventors: Shijia Pan, Merced, CA (US); Yue Zhang, Merced, CA (US); Zhizhang Hu, Merced, CA (US)

(73) Assignee: THE REGENTS OF THE UNIVERSITY OF CALIFORNIA, Oakland, CA (US)

(21) Appl. No.: 18/647,742

(22) Filed: Apr. 26, 2024

Related U.S. Application Data
(60) Provisional application No. 63/462,617, filed on Apr. 28, 2023.

(51) Int. Cl. H04L 12/28; G05B 15/02; G05B 19/418

(52) U.S. Cl. CPC H04L 12/2827; G05B 15/02; G05B 19/418; G05B 2219/2642

(57) ABSTRACT

Cross-modal association (CMA), such as cross-modal signal segment association, is described for associating structural vibration and wearable sensors. This includes an Association Discovery Temporal Convolutional Network (AD-TCN) that determines the amount of shared context between a structural vibration sensor and associated wearable sensor candidates from the parameters of the trained model. CMA achieves improvements in AUC values, F1 scores, and accuracy over relevant baselines. In at least one embodiment, the vibration sensor is associated with a physical structure, the wearable sensor is associated with a person, and the modules estimate association between vibration sensor signals and a person who induces the vibration sensor signals interior to the structure.

### CROSS-REFERENCE TO RELATED APPLICATIONS

This application claims priority to, and the benefit of, U.S. provisional patent application Ser. No. 63/462,617 filed on Apr. 28, 2023, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to smart homes, and more particularly to indoor occupant sensing.

### 2. Background Discussion

Indoor occupancy sensing is becoming more prevalent and beneficial. However, as these system often rely on multiple sensing modalities, accuracy issues can arise, and activity can be mischaracterized.

Accordingly, a need exists for an apparatus and method for more accurately creating cross-modal associations. The present disclosure fulfills that need and provides additional benefits over existing systems.

### BRIEF SUMMARY

Indoor occupant sensing enables many smart building applications, such as home, care facilities, hospice, retail stores, in which various sensing systems have been explored. Based on their installation requirements, the present disclosure considers two categories of sensors, namely on- and off-body, and the combination of them for occupant sensing due to their spatial and temporal complementarity. In one example embodiment, a modality pair of wearable Inertial Measurement Unit (IMU) sensors and structural vibration may be used simultaneously to demonstrate modality complementarity. However, the knowledge of the signal segments from two modalities is necessary, which is a challenge in a multiple occupants co-living scenario. Therefore, establishing accurate cross-modal signal segment associations is essential to ensure that a correct complementary relationship is achieved.

Cross-Modal Association (CMA) is a Cross-Modal signal segment Association scheme between structural vibration and wearable sensors. It presents Association Discovery Temporal Convolutional Network (AD-TCN), a framework built upon a temporal convolutional network that determines the amount of shared context between a structural vibration sensor and associated wearable sensor candidates from the parameters of the trained model. CMA may be evaluated using a public multimodal dataset for systematic evaluation whereby a continuous uncontrolled dataset for robustness evaluation is collected. CMA achieves up to 37% Area under the receiver operating characteristic (ROC) curve (AUC) value, 53% F1 score, and 43% accuracy improvement compared to baselines. It should be noted that F1 scores are well-known as a machine learning metric that can be used in classification models.

In one embodiment, a system is described for CMA between wearable and structural vibration signal segments for indoor occupant sensing, including a multimodal signal alignment module, an AD-TCN module, and an association probability estimation module, wherein the modules in combination are configured to estimate association relationship between a vibration sensor and a wearable sensor. In one embodiment, the vibration sensor is associated with a physical structure, the wearable sensor is associated with a person, and the modules estimate association between vibration sensor signals and a person who induces the vibration sensor signals interior to the structure.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is an association diagram of the cross-modal signal segment association problem in identifying associated segment pairs in response to being given a set of segments from two sensing modalities collected during the same period, according to at least one embodiment of the present disclosure.

FIG. 2 is a block diagram of CMA according to at least one embodiment of the present disclosure.

FIG. 3A through FIG. 3D are graphs of structural vibration event detection and activity segmentation signal examples, according to at least one embodiment of the present disclosure.

FIG. 4A and FIG. 4B are block diagrams of architecture of the AD-TCN and Causal Convolution Layer, respectively, according to at least one embodiment of the present disclosure.

FIG. 5A through FIG. 5E are graphs of signal inputs and predictions with and without the associated wearable device, according to at least one embodiment of the present disclosure.

FIG. 6A through FIG. 6C are graphs of CMA performance results with the public dataset as determined according to at least one embodiment of the present disclosure.

FIG. 7A through FIG. 7D are graphs showing distribution of associated and Unassociated Probability (unAP) of CMA and baselines, as determined according to at least one embodiment of the present disclosure.

FIG. 8A through FIG. 8C are graphs of ROC curves for CMA when using the public dataset, as determined according to at least one embodiment of the present disclosure.

FIG. 9A through FIG. 9D are graphs illustrating the impact of CMA configurations and repeatability of CMA, as determined according to at least one embodiment of the present disclosure.

FIG. 10A through 10C are graphs of overall performance with the uncontrolled dataset, according to at least one embodiment of the present disclosure.

FIG. 11A and FIG. 11B are performance bar charts for two use cases with cross-modal association information provided by CMA, as obtained from at least one embodiment of the present disclosure.

### DETAILED DESCRIPTION

### 1. Introduction

Indoor occupant sensing enables many smart home applications, such as elderly care, building management, and personalized service. Various sensing modalities have been explored, and these systems fall into two categories based on whether it requires the occupant to carry extra devices: on-body and off-body sensing. Fusing on-body and off-body sensing is prevalent in indoor occupant sensing, if multimodal signals can provide complementary information for the same target, and therefore achieve robust information inference. Among these combinations, wearable and structural vibration sensing have demonstrated efficient complementarity for various inference tasks. However, when the size of these Internet-of-Things (IoT) systems increases, they may sense multiple physical activities occurring at the same time. For example, for an IoT system deployed over different areas in a house, they may sense people performing different activities in different areas. It also means that for any pair of cross-modal sensors, the physical activity they are sensing may or may not be the same. If signal segments of two sensing modalities that capture different activities are used for inference, a spurious complementary relationship will be used. Therefore, it is of great importance to establish correct association relationships for signal segments from co-located sensors of different modalities.

This CMA relationship is beneficial for multiple use cases, such as user signal segment annotation and enhancing multimodal learning efficiency. In user signal segment annotation, wearable and structural vibration sensors are used together to allow the wearable sensors to be used as the identity annotation tool for the structural vibration sensors' signal segments, since the wearable is already associated with its user. This could further advance the structural vibration sensing-based IoT system's usability and scalability as a zero-effort bootstrapping user annotation scheme. In the case of enhancing multimodal learning efficiency, using a high-accuracy signal segment association, multimodal learning can leverage this prior knowledge to achieve more accurate modeling, since falsely associated signal pairs may result in spurious complementary relationship being modeled.

Cross-modal IoT device pairing/identification is a relevant topic to cross-modal signal segment association. Prior work on cross-modal pairing relies on the shared context that can be sensed by both sensing modalities and comparing the similarity of the acquired shared context to achieve the pairing or identification. Some approaches leverage the shared 3D motion (spatial context) of human body parts captured by both camera and IMU sensors to achieve IoT device identification, and some approaches utilize the shared context of activity start time and/or end time (temporal context) to generate fingerprints for co-located device pairing. However, these approaches suffer challenges which arise from their constrained shared context.

### 1.1. Proposed Solution

This disclosure describes techniques to overcome challenges presented by constrained shared context. The techniques disclosed herein use the temporal convolutional network to efficiently discover the limited association information without the benefit of an explicitly shared context. The present disclosure refers to these techniques as “Cross-Modal Association” or “CMA”.

### 1.2. Cross-Modal IoT Device Identification

Cross-modal IoT device pairing and/or identification is a relevant topic to cross-modal signal segment association. Prior work on cross-modal pairing relies on the shared context that can be sensed by both sensing modalities and comparing the similarity of the acquired shared context to achieve the pairing or identification. Some approaches leverage the shared 3D motion (spatial context) of human body parts captured by both camera and IMU sensors to achieve IoT device identification, and some approaches utilize the shared context of activity start time and/or end time (temporal context) to generate fingerprints for co-located device pairing. However, these approaches are not desirable due to the challenges from constrained shared context. CMA solves these challenges by using the temporal convolutional network to efficiently discover the limited association information without an explicitly shared context.

### 1.3. Internet of Things (IoT) for Occupant Identification

The fundamental problem solved by the approaches described in this disclosure is to associate the infrastructure sensor signals with the individual (e.g., a person or object) that induced it, which is also relevant to the sensor signal-based identification problem. Prior work on occupant identification has explored the possibility of identifying the person based on how their behavior or interaction with the environment varies. A more specific description of human behavior is the walking pattern or gait, which can be observed by a wide range of sensors. Other biometrics are also explored to enable ubiquitous occupant identification in the smart home setting such as voice, or characteristics of the human body, such as its reflection, refraction, diffraction, and/or even absorption of radio signals. However, all these identification systems require an occupant identity label to create the corresponding classifier model to achieve the identification. Thus, it is often difficult and impractical to assume the availability of labeled data for each deployment.

As such, the present disclosure leverages the wearable sensor and its natural association with individuals who wear them to ‘label’ the identity of the infrastructure sensing segment as a signal association problem.

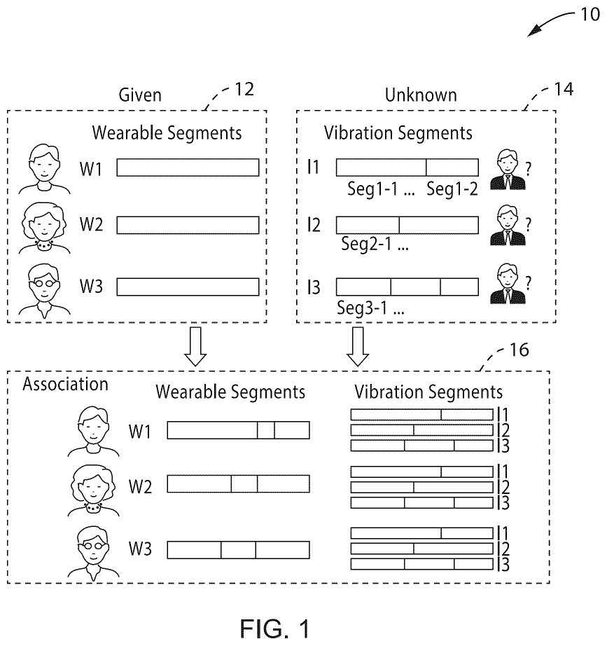

FIG. 1 illustrates 10 the cross-modal signal segment association problem formulated between wearable and structural vibration sensors. Wearable segments 12 data may be received from different individuals, whereas vibrational segments 14 can be received and associated with an unknown individual or individuals. The apparatus and method of the present disclosure 16, upon being given a set of segments from two co-located sensing modalities collected during the same period (e.g., Seg1-1, . . . Seg3-1), provides for determining a segment-level association cross modalities (e.g., Seg1-1: P1-I1, Seg2-1: P2-I1). However, this form of cross-modal signal segment association has the following challenges:

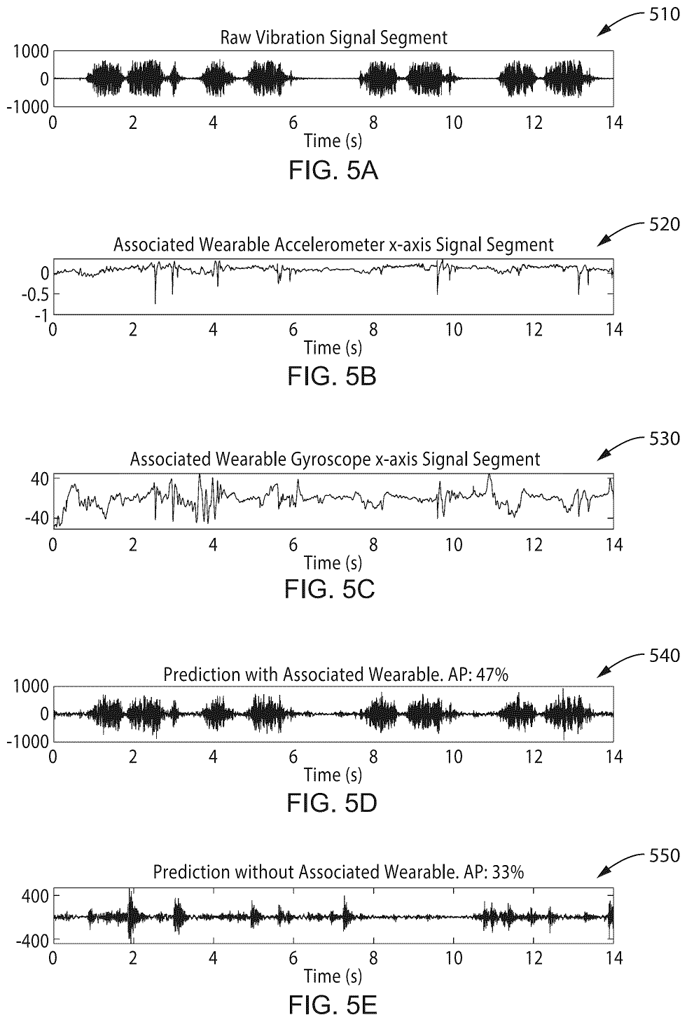

(a) Indirect sensing leads to the lack of direct comparable information. For indirect sensing systems of structural vibration and IMU, their raw measurements often cannot be directly interpreted, and therefore, cannot be readily compared to determine a shared context (e.g., signal examples as illustrated in in FIG. 5A through FIG. 5D).

(b) Complementary modalities often lead to disassociation. IoT systems that adopt multiple modalities often leverage the complementarity to achieve more efficient modeling. However, the more complementary the two modalities are, the less shared information they capture, and hence their signal segments are more difficult to determine an associated with. For example, prior work that conducts location association between the electric load sensor and microphone required longer measurements than that of the camera and IMU, because the latter leverages a clear shared context of acceleration.

(c) Mobility variance often leads to spatiotemporal variation. For modalities with different levels of mobility, this association may vary over time. For example, occupants which each carry an on-body sensor may move in the house and can be captured by different off-body sensors. Therefore, this association relationship varies over time due to the mobility of the occupants.

CMA may be described as a cross-modal signal segment association scheme between wearable and structural vibration sensors. To determine whether two signal segments from different modalities over the same period are associated, an Association Probability (AP) may be determined. The intuitions to determine this AP are twofold: (1) as long as the sensors are capturing the same physical activity, there will be an implicit shared context between two signal segments, and (2) it is assumed herein that for the structural vibration signals that are segmented as one activity (e.g., five seconds, 8 seconds, 10 seconds, or any other desired time series and/or activity), there will be only one wearable sensor associated to it.

The temporal convolutional network (TCN) has shown efficient learning ability for the temporal representation features from time series signals. AD-TCN is a framework built upon TCN to calculate the amount of shared context between signal segments from different modalities. First, AD-TCN takes all candidate wearable segments and the vibration segment history values to predict the vibration segment's current time step value. Then the model is trained and calculates the association probability between signal segments from two modalities based on the weights of the trained AD-TCN. The association probability reflects the contribution of one signal segment for predicting the other. If the contribution of a signal segment is higher than a threshold, then it is considered that this wearable signal segment is associated with the vibration signal segment, i.e., they detect the same physical activity.

In summary, (a) CMA, a cross-modal sensing signal segment-level association scheme for multimodal IoT systems is introduced; (b) the process of AD-TCN learns the segment-level cross-model representation and uses the learned model parameters to calculate the amount of shared context between modalities; and (c) CMA is evaluated through both a public dataset and an uncontrolled real-world dataset for a robust analysis.

### 2. CMA Design

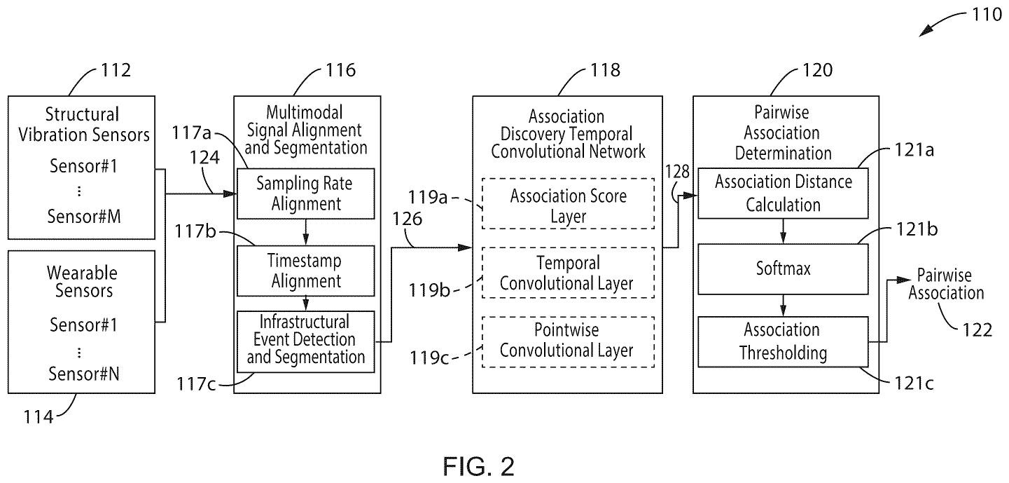

FIG. 2 illustrates an example embodiment 110 of a CMA architecture comprising three modules to estimate the association relationship between the structural vibration and wearable sensors. Sensor inputs comprise one or more structural vibration sensors 112 in combination with one or more wearable sensors 114. The signals 124 from these sensors are directed to a multimodal signal alignment and segmentation module 116. CMA is utilized to align 117a signals 124 from all sensors by aligning their timestamp and sampling rate, so that these signals 124 are comparable temporally (as described below in Section 2.1). Then a threshold-based event detection process 117b is applied to detect the valid events from the structural vibration data (e.g., such as a timestamp alignment or any other known threshold-based event detection method), and then timestamp of the structural vibration events are utilized in segmenting 117c the wearable IMU data.

The segmented multimodal events 126 which are output from module 116 are received by an Association Discovery Temporal Convolutional Network (AD-TCN) 118, which comprises an Association Score Layer 119a, Temporal Convolution Network 119b, and a Pointwise Convolutional Layer 119c. In this process, for each structural vibration sensor, an AD-TCN is trained and the weight values of the association score layer are output 128 (as described below in Section 2.2).

Finally, the association score layer output 128 is received at the Pairwise Association Determination module 120 which comprises Association Distance determination 121a, Softmax determination 121b, and Association Thresholding 121c. In this process the Pairwise Association Determination module 120 receives the CMA determination of the pairwise Association Probability (AP) 122 between each structural vibration sensor and each wearable (as described below in Section 2.3). The present disclosure considers the pair of the wearable and the structural vibration sensor with the association probability higher than a threshold is associated (i.e., they detect the same occupant).

The following sections describe more specifically the operations outlined in FIG. 2.

### 2.1. Multimodal Signal Alignment and Segmentation

In module 116 incoming signals 124 are received. Due to the heterogeneity of the two sensing modalities, these signals are first preprocessed by aligning and segmenting the signal of interest. Since different types of sensors are sampled at different rates, the number of samples in the same event duration may vary. Furthermore, since a Temporal Convolutional Network (TCN) architecture is utilized for association discovery (as described below in Section 2.2), the architecture takes the same length of time series data points as input and outputs. Therefore, it is important to ensure that all the sensor inputs have the same number of samples in each second, and samples over all the sensor inputs are temporally aligned (as described below in Section 2.1.1). In addition, since in the example application scenarios the wearable sensors are directly associated with the user, the identities and the structural vibration sensor signals need to be associated with the user identities as CMA only conducts association when there is a vibration signal detected (as described below in Section 2.1.2).

### 2.1.1. Sampling Rate and Timestamp Alignment

To ensure accurate multimodal temporal information modeling, the sampling rate over all the sensor inputs is aligned first. Then the lowest sampling rate Q (reference) of all available sensors is selected as the reference. Then resampling is performed on each of the other sensor inputs. Using a signal with an original sampling rate of P Hz as an example (P≥Q, and P, Q∈ [symbol] ⁺). To resample the signal, the least common multiple (LCM) of P and Q is determined first. Then the linear interpolation is conducted to up-sampling the P Hz sampling rate data to LCM Hz. Next, a low-pass filter is applied to remove the higher frequency (>P) components in the up-sampling series. Finally, the up-sampling series is down-sampled to Q Hz.

Since the TCN leverages the temporal relationship between historical samples and current samples to establish models, it is important to have samples from all sensors time-aligned. Therefore, based on the periodically provided timestamp, CMA interpolates the timestamp for each sample for high-resolution alignment.

### 2.1.2. Structural Vibration Event Detection and Activity Segmentation

Additionally, steps are performed to detect the event of interest to conduct temporal association on, by using a threshold-based event detection method on the vibration data.

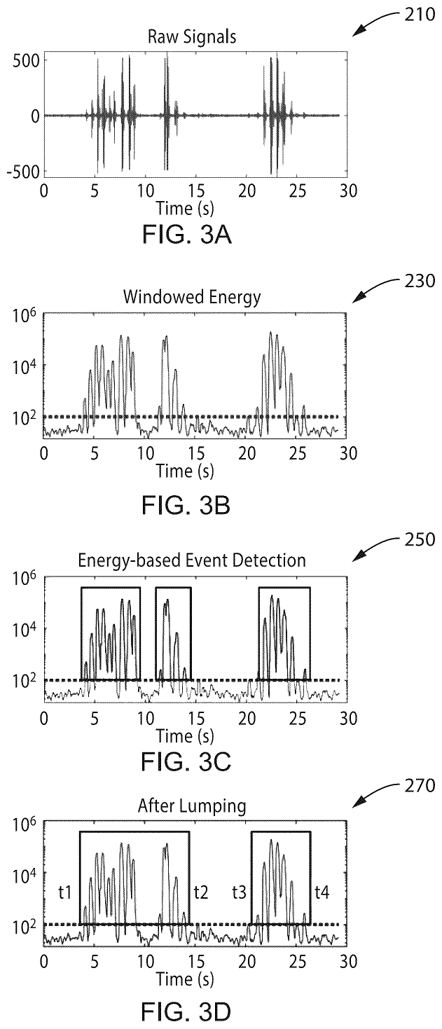

FIG. 3A through FIG. 3D illustrate example results of structural vibration event detection and activity segmentation signal examples. FIG. 3A depicts a graph 210 of raw signals of human-induced structural vibration. FIG. 3B depicts a graph 230 of signal energy of the sliding window applied to the signal in FIG. 3B. In FIG. 3C is depicted results 250 of energy-based event detection on the windowed signal energy, where the detected events are marked by the boxes. In FIG. 3D is depicted events with intervals lower than a pre-selected threshold which are lumped as one activity, which is marked by the box. For example, the segment from t1 to t2 contains signals of one activity. The following provides additional details of these graphs.

First a sliding window is applied on the time sequence data of the vibration sensor of FIG. 3A and determines the energy of the windowed signal as seen in FIG. 3B. The windowed signal energy of the ambient noise is characterized as Gaussian noise (μₙ, σₙ). Then, a lower bound θₑ is selected as the energy threshold of the windowed signal. If the energy of this windowed signal is larger than (μₙ+θₑ*σₙ), then this embodiment considers this window as an event (FIG. 3C).

Next, activity segmentation is conducted with an interval-based lumping method, where the consecutive events are segmented that are less than the event interval threshold &r as one activity segment (AS) (FIG. 3D). The present disclosure segments the aligned IMU data consistently with the structural vibration sensor segments. The start and end time of the activity segment is data-driven; therefore it does not provide semantic meanings, and one segment may represent that activity of two different people which is occurring consecutively within Δτ. To ensure efficient association, the activity segments are further segmented into Association Units (AU) to unify the association signal with lower and upper bounds, τₗ and τᵤ. In at least one embodiment, it is assumed that the association of the signals does not change within an AU. For a segmented AS, if the duration is shorter than τₗ, CMA discards it because there is insufficient information to perform the association. Otherwise, if the duration is longer than τᵤ, the AS is divided into multiple AUs by the duration ≤τᵤ, and discards ones with a duration <τₗ. The aligned AUs from two modalities are inputs for the next module.

### 2.2. Association Discovery Temporal Convolutional Network (AD-TCN)

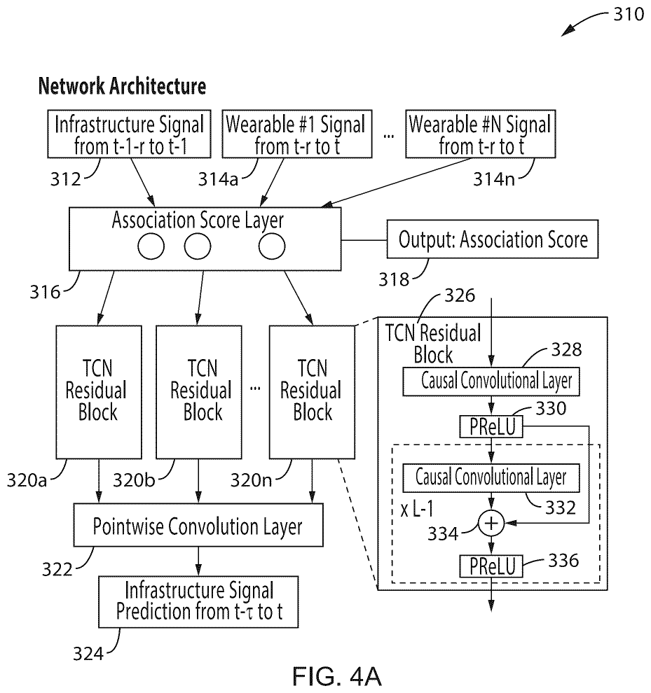

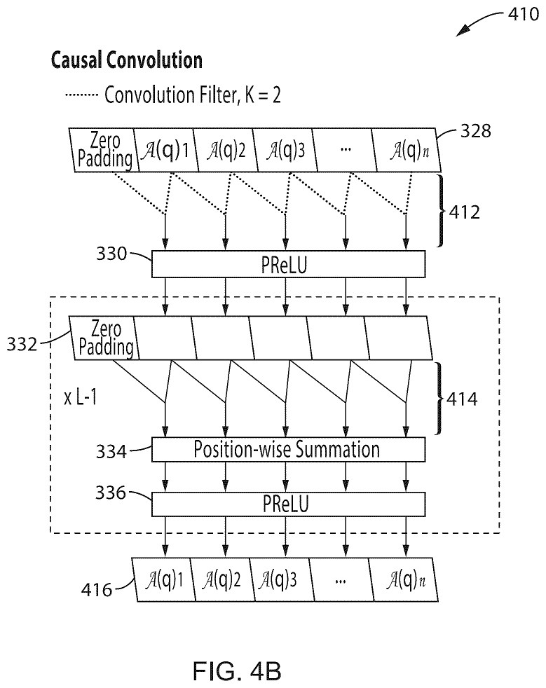

FIG. 4A and FIG. 4B illustrate an Association Discovery Temporal Convolutional Network (AD-TCN), showing the architecture of the AD-TCN in FIG. 4A, and the Causal Convolution Layer in FIG. 4B.

In addressing the CMA problem, the wearable IMU measures the occupant's motion, which causes the structure to vibrate. Inspired by the prior work that utilizes the TCN architecture to infer Granger causality, this embodiment of the present disclosure models the cross-modal signal association problem as a time series prediction problem and quantifies the contribution of one segment (X) on the prediction of another segment (Y) as an indicator of such association relationship. In the model of the present disclosure for an AU of duration τ at time step t, at least one embodiment considers X is the raw signal of the wearable sensor between t−τ and t, and Y is the raw signal of the structural vibration sensor between t−τ and t−1. If the past value of X at t−τ to t contributes to predict Y at t, then X and Y are associated with an association probability proportional to this contribution.

The present disclosure presents AD-TCN, an Association Discovery network built upon the TCN architecture to infer causal relationship between pairs of multimodal sensing signals.

FIG. 4A illustrates an example embodiment 310 of the AD-TCN. Inputs are shown as infrastructure signals 312, and wearable signals 314a through to 314n. In at least one embodiment, the network 310 has three parts, namely, the association score layer 316, TCN residual blocks 320a, 320b through 320n, and a point-wise convolution layer 322. The network 310 receives aligned AU of duration τ with η=τ×Q samples from index η₀ as inputs. For wearable sensor signals, the input is signal indexed between η₀ and ζ₀+η. For structural vibration sensor signals, the input ranges from η₀−1 to η₀−1+η. The prediction output is the structural vibration sensor signal indexing from η₀ to η₀+η. For each structural vibration sensor's AUs and n available signals from wearable sensors, an AD-TCN network is trained independently to estimate the association relationship.

### 2.2.1. Association Score Layer

The present disclosure introduces a trainable association score layer to measure the weight applied on each channel of sensor signals by the network.

In FIG. 4A, association score layer 316 and its inputs and outputs are shown. For a multimodal sensing system with M wearable sensors (the i^{th} sensor has Cᵢ channels), the association score layer contains h=1+Σᵢ₌₁^{M}Cᵢ nodes, shown as circles in FIG. 4A, each containing a weight value. In the beginning, all nodes are initialized with the same weight value, for example each input equally contributes to structural vibration signal prediction. These weights are updated during model training by the gradient descent process. The association score is determined from the weight, such as utilizing a normalized exponential function, here exemplified as a SoftMax function, as the layer's activation function. When model training is completed, the final association score is output to the Pairwise Association Determination module as seen in FIG. 2. A high association score indicates that this node's input has more contribution to predicting the structural vibration signal, and the input signal of this node is more likely associated with the structural vibration signal. On the other hand, during model training, the association scores are multiplied with their corresponding input signal as the output of the layer. For input multimodal signal segments with length η=τ×Q, the output of the association score layer is shown as follows:

$$𝒜 ( q ) = {α}_{q} \cdot {SE}_{q} = \frac{{exp}^{{W}_{q}}}{{Σ}_{j = 1}^{h} {exp}^{{W}_{j}}} \cdot {SE}_{q} \qquad ( 1 )$$

$$𝒜 ( q ) ∈ {ℝ}^{η \times 1} , q ∈ [ 1 , h ]$$

where SE_{q}∈ [symbol] ^{η×1} is the q th input, α_{q} and W_{Q} are the association score and the weight of qth node, respectively.

### 2.2.2. Temporal Convolutional Network Residual Block

A TCN residual block may be used for its strong performance in time-series prediction. Transitional TCN is designed for univariate time-series prediction, such as predicting with one time-series data. However, CMA models the association problem as a time-series prediction problem with multiple time-series data inputs, thus multivariate time-series prediction. To adapt to the multivariate time-series prediction, a depth wise separable architecture is utilized to extend the univariate TCN architecture for multivariate prediction. That is to say, that outputs from the association score layer for each node are separately sent to different TCN residual blocks 320a-320n, as shown in FIG. 4A. In total, there are h (320a through 320n) independent TCN residual blocks.

As seen in FIG. 4A each TCN residual block has the same architecture 326 as seen at the right in the figure, having L layers of 1-D causal convolutional network layers 328. These layers have the same kernel size K. After each causal convectional layer 328, a Parametric Rectified Linear Unit (PReLU) 330 is adopted as the non-linear activation function, for its empirical strong performance on improving model fitting capability. A residual connection is added before each PReLU activation result in the block, except the first one. The residual connection conducts a position-wise summation 334 of the previous 330 and current layers' 332 results to PReLU 336 from which output is made to the pointwise convolution layer 322. This allows the block to learn modifications on the block input rather than the entire transformation, which has been shown to benefit scaling the network to very deep.

FIG. 4B illustrates an example embodiment 410 of the mechanism of 1-D causal convolution in the TCN residual block. The ‘causal’ in this layer architecture name means (e.g., indicates) that the prediction of time t data is generated only with data from time t and earlier. For instance, to predict [symbol] (q)₃, only the data no later than [symbol] (q)₃ 328 is used. In this way, no future information is used in prediction i.e., no information leakage. Each causal convolutional layer has the same length (η) as the input time-series signal. Since only the history data can be used for prediction, in order to keep subsequent layers, the same length as the first layer, a left zero-padding of size K−1 is added. Regions 412 and 414 depict convolutional filters, which are matrix/array of numerical values. 416 presents the output of the convolutional layer, which is a different matrix/array of numerical values.

The set of calculations of the q th block can be described as follows:

$${𝒯}_{1} ( q ) = PReLU ( {G}_{q}^{1} * 𝒜 ( q ) + {b}_{q}^{1} ) \qquad ( 2 )$$

$${𝒯}_{l} ( q ) = P R e L U ( {G}_{q}^{l} * {𝒯}_{l - 1} ( q ) + {b}_{q}^{l} ) + {𝒯}_{l - 1} ( q )$$

$${𝒯}_{1} ( q ) , {𝒯}_{l} ( q ) ∈ {ℝ}^{η \times 1} , l ∈ [ 2 , L ]$$

where [symbol] (q) and [symbol] (q) are the output of the first layer and l th layer, G_{q}¹, G_{q}¹∈ [symbol] ^{K×1} are weights of the convolution filters in the first layer and l th layer, and b_{q}¹, b_{q}¹∈ [symbol] are bias terms of each layer. K is the kernel size of the convolution filter, while ‘*’ denotes the convolution operator.

Receptive field is a term that describes the amount of history data which is utilized in the prediction, and it has been proven that the size of the receptive field has an impact on prediction accuracy. There are two hyper-parameters in the TCN residual block that jointly determine the receptive field size: L, number of causal convolutional layers; and K, kernel size of the 1-D convolution filter. Additionally, the same receptive field can be achieved using a different composition of K and L, however, it should be appreciated that the properties of the network may impact performance. For instance, a large L may make model training more difficult and cause overfitting. The evaluation of receptive field size F and hyper-parameters setting (K and L) on the system performance is described below in Section 4.3.

### 2.2.3. Pointwise Convolution Layer

The pointwise convolution layer 322 of FIG. 4A is applied to integrate the output of all h TCN residual blocks as the prediction of the structural vibration segment. The output 324 in FIG. 4A from the pointwise convolution layer is an infrastructure signal prediction from t-τ to t, that has the same length η of the input time-series signal segments. The determination of the pointwise layer is as follows:

$$\hat{𝒥} = {\sum }_{q = 1}^{h} {p}_{q} \cdot {𝒯}_{l} ( q ) \qquad ( 3 )$$

$$\hat{𝒥} ∈ {ℝ}^{η \times 1}$$

where p_{q}∈ [symbol] is the weight of the pointwise convolution filter for the qth TCN block output.

### 2.2.4. Loss Function

By way of example and not intended as a limitation, the Mean-Square-Error (MSE) may be used as the loss function to measure the difference between the raw vibration sequence (l) and the predicted sequence ( [symbol] ). The determination of MSE is as follows:

$$ℒ = \frac{{Σ}_{r = 1}^{η} {( I ( r ) - \hat{𝒥} ( r ) )}^{2}}{η} \qquad ( 4 )$$

where η is the length of the AU. MSE reflects how similar the predicted sequence [symbol] and the ground truth l are. The optimization goal is to minimize [symbol] during the model training.

### 2.3. Pairwise Association Determination

The output from the AD-TCN module 118 of FIG. 2, is then received at the Pairwise Association Determination module 120. To enable explainable association, CMA estimates an AP for each τ seconds multimodal data based on the AD-TCN output. The output, “association score”, is the attention value of the neural network for each input and cannot represent the association relationship directly. Furthermore, since AD-TCN is applied to each structural vibration sensor, the weight values of different AD-TCN are not comparable.

Therefore, a common representation of the association relationship between the structural vibration and wearable sensors are needed. To accomplish this, a ‘divergence’ is first determined, thus an association distance is determined 121a as in FIG. 2, between the structural vibration sensor and all the available wearable sensors using the association score. Next, a normalized exponential function, such as the SoftMax function, by way of example, is applied to convert the association divergence to the AP between the structural vibration sensors and wearable sensors. In this way, a common measurement is found of the association relationship between multiple structural vibration sensors and wearable sensors.

The association divergence measures the association relationship between the structural vibration sensor and wearable sensor. A low association divergence value means the IMU has less contribution on the prediction of the target vibration sensor, i.e., they have a lower probability to be associated. For the wearable sensor q with C channels, CMA outputs C values of association score, as a vector W_{q}. CMA integrates the C channels of the association score into a divergence D_{q} as the square root of Euclidean norm of the vector W_{q}.

$${D}_{q} = \sqrt{{Σ}_{i = I}^{C} {{W}_{q} ( i )}^{2}} \qquad ( 5 )$$

It should be noted that this D_{q} alone, or the vector W_{q} alone is not comparable to each other, because the association score for each structural vibration sensor are determined individually by a neural network. Therefore, they cannot be directly compared to a global threshold. To allow explainable and comparable outputs, a further step of normalizing this divergence by SoftMax is performed, and output the AP as given by

$$A P = \frac{{exp}^{( {D}_{q} )}}{{Σ}_{i = 1}^{N} {exp}^{( {D}_{i} )}} \qquad ( 6 )$$

CMA reports an association if the AP value is larger than a threshold θ_{AP}.

FIG. 5A through FIG. 5E illustrate example results showing signal inputs and predictions with and without the associated wearable device. FIG. 5A shows associated structural vibration 510, with FIG. 5B and FIG. 5C showing signal segments 520, 530 from the wearable device, while FIG. 5D depicts predicted structural vibration segment 540 with associated wearable segment and FIG. 5E depicts predicted structural vibration segment 550 without the associated wearable segment. The structural vibration segment predicted with the associated wearable's signal shows higher similarity to the raw structural vibration signal segments. CMA outputs AP of FIG. 5D and FIG. 5E were found to be 47% and 33%, respectively. This AP difference indicates that the AD-TCN learns the implicit shared context between the structural vibration and wearable segments.

It will be noted that FIG. 5A shows an example AU input of duration τ=14s with the structural vibration signal segment, while the wearable segments are shown in FIG. 5B and FIG. 5C. By directly comparing FIG. 5A to FIG. 5B and FIG. 5C, a clear association is not observable between their waveforms.

However, by using the disclosed CMA operations with this AU as inputs, the predicted structural vibration segment shown in FIG. 5D shows a high similarity to FIG. 5A. On the other hand, if the input of the wearable segment is replaced with a signal segment of the same dimension with value 0, i.e., a segment has no information, the predicted segment is as shown in FIG. 5E, which demonstrates a lower similarity to FIG. 5A. The AP of the associated IMU sensor (#1 47%) is higher than that of the other two IMU sensors (#2 26% and #3 27%). The AP between all zeros sequence (33%) and unassociated IMU sensors (#2 35% and #3 32%) are similar to an even distribution (random guess 33%). Therefore, the association probability can reflect the association for cross-modal signals.

### 3. Experimental Setup

CMA from two aspects may be evaluated as follows: (1) Evaluation is performed on the association performance and system characterization on the public dataset and our collected uncontrolled dataset; (2) The evaluation utilizes case studies for real application demonstration.

A set of controlled experiments for system characterization on the public dataset may be conducted first, including hyperparameter configuration, on the impact of human activity category and AP distribution. Then, performance is evaluated for uncontrolled experiments for robustness verification. Finally, two use cases are implemented on the public dataset to demonstrate how to adapt CMA in real applications, including occupant identification and multimodal human activity recognition.

Two datasets (one open-sourced and one real-world collected), ground truth, evaluation metrics, as well as the implementation of baselines, CMA, and two use cases are described below. The testing was conducted based on the guideline approved by the University Institutional Review Board (IRB) review.

### 3.1 Datasets Description

### 3.1.1 Public Dataset

The dataset used in the examples below include both structural vibration and wearable sensors, for example floor vibration sensors and on-wrist IMU (6-axis) sensors. The dataset is collected over two buildings with six human subjects with nine types of in-home activities of daily living. The nine types of in-home activities of daily living are keyboard typing, using a mouse, handwriting, cutting food, stir-fry, wiping countertops, sweeping the floor, vacuuming the floor, and opening closing drawers. It should be appreciated that the activities are given above by way of example and is not meant to be limiting, as the present disclosure is amenable for use with different types of sensors and for operation across any desired set of activities. For each scenario, for example one building, one human subject conducting nine types of activities, signals from four vibration sensors deployed in the house, and one IMU sensor deployed on the human subject's wrist are collected. Each human subject conducts the same set of activities in each scenario for 10 times and each time performs those activities for approximately 15 seconds. The sampling rates of the vibration sensor and the IMU sensor are 6500 Hz and 235 Hz, respectively. The dataset also contains the ground truth of activity types and start and end timestamps.

### 3.1.2. Continuous Uncontrolled Dataset

The present disclosure adopts the same types of sensors, and sampling rates as the public dataset and collects the continuous uncontrolled datasets over five houses. In one test, 11 human subjects were recruited in total, and it was maintained to have three subjects per house for the data collection. In each house, three vibration sensors were deployed on the surface of the furniture (desk, kitchen bar, etc.) to capture the subject induced vibration signals, including the kitchen area, living area, and dining area. Considering there are about 2.5 people per household on average in the United States in 2021, three participants were invited to cohabit in each house, and each participant wore an IMU sensor on their wrist. The six-axes IMU data (three-axes accelerometer and three-axes gyroscope) was collected from the three participants simultaneously. The duration of data collection in each house was approximately one hour. The participants conducted their daily activities in each area: cooking in the kitchen area, eating in the dining area, and watching TV or surfing on the Internet with a laptop in the living area. To reflect the diversity of the participants' activities, the participant could do any activity in each area as natural as possible. For example, the subject could cook any food they like; some subjects cooked potatoes, some cooked sandwiches. In practice, the sampling rate of the vibration sensor and the IMU sensor were around 4000 Hz and 250 Hz, respectively. In addition, a camera was deployed in each area to record which participant was active in each area.

### 3.2. Ground Truth of Pairwise Association and Dataset Preparation

The cross-modal association problem is described as determining if the signals from two sensing modalities for a given period are induced by the same physical event, which is the individual activity in the studied case. For an AU, the ground truth of the association between the vibration signal and the IMU signal is true if and only if the vibration signal is induced by the individual wearing the IMU.

### 3.2.1. Public Dataset

To utilize the Public Dataset for evaluating CMA on the task of CMA, association ground truth was generated based on the provided original activity ground truth. First detection and segmentation was performed for each activity event based on the provided start and end timestamp of each activity event. For each activity segment with signals from four vibration sensors and one IMU sensor, the vibration sensor is selected having the highest signal-to-noise ratio (SNR) as the signal associated with the corresponding IMU sensor. The process then proceeded through the entire dataset and generated 1048 pairs of the cross-modal association data segments (each approximately 10 seconds). For any two cross-modal segments VibSigᵢ and IMUSigⱼ, the association labe is true if i=j, otherwise is false.

For each trial, N segment pairs were randomly selected from the candidate set (it can be the full set with 1048 pairs or a subset). Then CMA was applied on each VibSig with all the IMUSig_{1, . . . , N} and output N APs between the VibSig and N IMUSig. To reflect the practical scenario of a home with parents and children, a default value for N was set as 3 by way of example and not limitation. For each experiment, this trial was repeated at least 100 times to reduce random selection bias.

### 3.2.2. Continuous Uncontrolled Dataset

For the continuous uncontrolled dataset, event detection and activity segmentation (as described above in Section 2.1.2) is first applied on each vibration sensor. The vibration segment and other segmented IMU segments combine an AU. The association ground truth of this AU was determined by watching the recorded video in the vibration sensor deployed area, and it was considered that the human subject who appears in this area during this event period as the inducer of this event. For each experiment, all detected AUs in one house are used to evaluate the performance of CMA in real-world experiments and evaluate the robustness of CMA by comparing the performance variation in different houses.

### 3.3. Evaluation Metric

Two metrics in the evaluation may be considered: (1) The first metric is a Receiver Operating Characteristic (ROC) curve, and its AUC value are utilized to evaluate the performance in all thresholds; (2) Secondly, an F1 score, and accuracy are determined to evaluate the performance in a selected threshold. In at least one embodiment of this disclosure, the former metric is usually selected to evaluate CMA and the baseline methods and use the latter metric to provide an intuitive evaluation of the overall performance in the public dataset and continuous uncontrolled dataset.

### 3.3.1. ROC Curve and AUC Value

In this sensor signal association problem, both the true positive (i.e., the structural vibration sensor's signal is associated to the wearable sensor that causes vibration) and false positive (i.e., the structural vibration sensor's signal is not associated to the non-causal wearable sensor) are important performance indicators. Therefore, the ROC curve and the AUC were adopted to evaluate each test. A ROC curve is a probability curve that systematically depicts the performance (true and false positive rates) change across the entire range of thresholds. To generate the ROC curve, different AP thresholds θ_{AP} are used and the true positive and false positive rates are determined. AUC measures the quality of the association irrespective of threshold values. Higher AUC values indicate higher levels of performance.

### 3.3.2. F1 Score and Accuracy

Since the final output of CMA is a pairwise association between two modalities, a further step of thresholding the AP is performed and the F1 score, and accuracy is determined. For each Association Unit (AU), if the IMU segment association matches with the ground truth, then the AU is considered a true positive (TP). If the associated IMU ID does not match with the association ground truth, then it is considered a false positive (FP); and vice versa, for a false negative (FN). The precision and recall are calculated as

$$Precision = \frac{T P}{T P + F P} ,$$

$$Recall = \frac{T P}{T P + F N} .$$

The F1 score is a function of precision and recall,

$$F 1 score = \frac{2 \cdot Precision \cdot Recall}{Precision + Recall} .$$

The accuracy is the percentage of correctly determined association cases and unassociated cases over all cases.

### 3.4. Baseline Methods

The shared context or similarity between cross-modal signals as baselines may be considered, so CMA is evaluated against three commonly used signal similarity metrics. For vibration data segments VibSigᵢ and IMU data segments IMUSigⱼ, and steps performed to determine: (1) Cosine similarity (CS), (2) max cross-correlation (MCC), and (3) Surface similarity (SS) between them are shown in Table 1. For IMU signals with six axes, the signal similarity is determined between each axis and the vibration signal and report the highest similarity over all six axes. For all the baseline methods, the higher value between VibSigᵢ and IMUSigⱼ means that the vibration segment i is more likely to be associated with IMU segment j.

### 3.5. CMA Implementation

### 3.5.1. Multimodal Signal Alignment

Since the sampling rate for the vibration sensor and the IMU sensor are different in the two datasets, the vibration sensing data was resampled from 6500 Hz to 235 Hz for the public dataset and the vibration sensing data resampled from 4000 Hz to 250 Hz for the continuous uncontrolled dataset to align the multimodal signal inputs. In testing, the resample function in Matlab can be utilized to re-sample the data, or other resample mechanisms can be utilized without limitation. The recorded timestamp is utilized to align the vibration sensing data with the IMU sensing data for the uncontrolled dataset. Empirically, the energy threshold Be may be set as eight, and the threshold of event interval Δτ as four seconds. In at least one embodiment, the upper bound of activity segments mu was set as 20 seconds and the lower bound of activity segments τl as 8 seconds. However, any number of seconds may be set as desired.

### 3.5.2. Association Discovery

For the AD-TCN model training, the Stochastic Gradient Descent algorithm may be utilized with ADAM as an optimizer. ADAM stands for Adaptive Moment Estimation and provides iterative optimization for minimizing the loss function during the training of neural networks. In at least one embodiment, the maximum training epochs are set as 6000. To avoid the impact of over-fitting or under-fitting of AD-TCN, the early stopping method is applied to automatically stop the training based on the loss decrease. A ReduceLROnPlateau function is used, which is integrated into PyTorch, to implement early stopping and set the factor and patience parameter as 0.5 and 4, respectively. The training is terminated when the learning rate drops to less than 0.001 (initially 0.01). Parameters of dilation and stride in Conv1d are both set as 1.

### 3.5.3. Association Threshold

The output of the SoftMax function (as described above in Section 2.3) may be used as the estimated AP between N IMU segments. If all IMU segments are not associated with the vibration segment, the ideal distribution of AP should be a uniform distribution. So, 1/N was selected in this specific embodiment as the association threshold for CMA. For the baseline methods, the mean value was selected over all detected events in each experimental set (100 trials in the public dataset) as the threshold to determine the association. Once the baseline values (CS, MCC, SS) between the vibration segment and the IMU segment is larger than this threshold, then they are reported as being associated.

### 3.6. Use Case Study

Two aforementioned use cases on the public dataset due to the availability of the identity and activity labels may be implemented, and used to consider the use case scenario of three participants to co-habit in a house. Three association conditions are investigated, as follows: (1) Ideal association (ground truth) in which the pair of IMU and vibration data are considered of their true associations. (2) CMA association is evaluated, in which the pair of IMU and vibration data are based on the output of CMA. (3) Random association (baseline) is evaluated, in which the pair of IMU and vibration data are randomly assigned. For learning models in at least one embodiment, a given percentage (e.g., 80%) was randomly selected for training, and the remainder for testing.

### 3.6.1. Occupant Identification

In scenarios of vibration-based in-home elderly or patient monitoring, it is challenging to acquire the identity labels of each occupant's vibration signals to bootstrap the learning model in the real-world deployment. In at least one embodiment, a temporary setup can be utilized with the IMU sensor used with the CMA association scheme to provide initial identity labels for the learning model for a household of three people. CMA is run to acquire the identity label of the structural vibration signal segments, and then an SVM model is trained on these segments with pseudo-labels from the association. The identification reports accuracy values over the three association scenarios.

### 3.6.2. Multimodal Human Activity Recognition (HAR)

In this use case, the multimodal HAR was conducted to depict the importance of CMA. Instead of directly fusing two types of sensor data with random association or to provide a manual label of this association (ideal), CMA was leveraged to provide this information. This association will then determine the input IMU-vibration signal pair to the multimodal learning training and testing for activity recognition. In at least one embodiment, the same fully connected neural network is utilized as the classifier to recognize the occupant activity. The model is trained with a cross entropy loss and the Adam optimizer. In at least one embodiment the accuracy of nine activities were leveraged in performing recognition over the three association scenarios.

### 4. Results and Analysis

### 4.1. Overall Performance

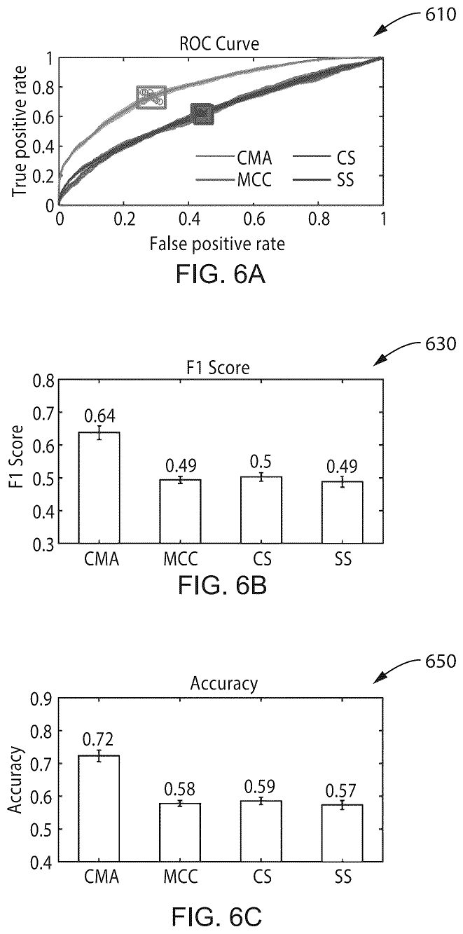

FIG. 6A through FIG. 6C illustrate graphs and charts of CMA association performance using the public dataset. In FIG. 6A is depicted 610 an average ROC curve and the standard deviation (i.e., width of the curve) of false positive rate and true positive rate in 10 tests. The bar charts of FIG. 6B and FIG. 6C depict the F1 score and accuracy as determined from the circled data points marked in FIG. 6A, respectively.

In the overall performance experiment, three pairs of segments were randomly selected out of the full set (i.e., 1048 pairs) to conduct the overall performance evaluation with the experiment procedure introduced above in Section 3.2. FIG. 6A shows the ROC curve of CMA and baseline methods. The solid line presents the average value of the ROC curve, and the area around the line presents the standard deviation of the 10-repetition experiments. It was observed that the ROC curve of CMA is always above those of the baseline methods, which indicates improved association accuracy. If a tolerable false positive rate of 0.2 is considered, then the average true positive rate CMA can achieve is 0.63, which is up to 1.5×(50% improvement) of the baselines (MCC 0.39, CS 0.40, SS 0.41). The average AUC value of CMA achieves 0.80, which is up to 30% improvement compared to the baselines (MCC 0.63, CS 0.62, and SS 0.64). FIG. 6B and FIG. 6C show the F1 score, and accuracy determined from the circled data points in FIG. 6A. The average F1 score of CMA and baselines achieve 0.64, 0.49 (MCC), 0.50 (CS), and 0.49 (SS), respectively. CMA achieves 1.3×F1 score value of the baseline methods (up to 31% improvement). The average accuracy of CMA and baselines achieve 0.72, 0.58 (MCC), 0.59 (CS), and 0.57 (SS), respectively. The accuracy of CMA achieves up to 26% improvement over the baseline methods.

### 4.1.1. AP Distribution

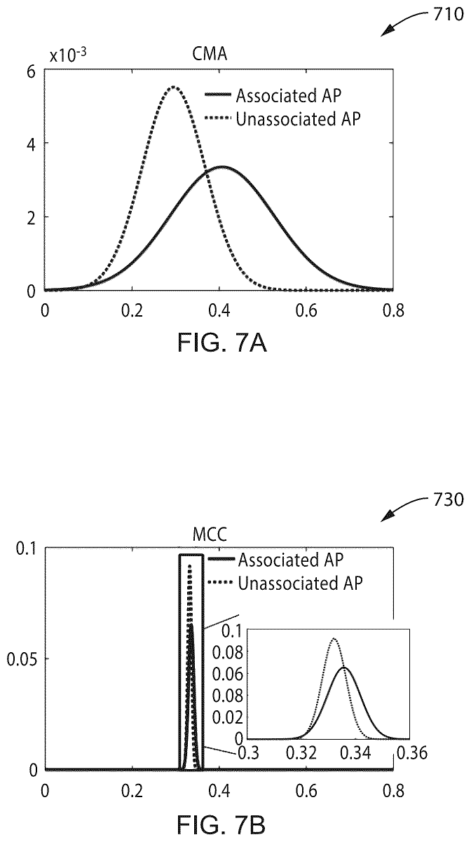

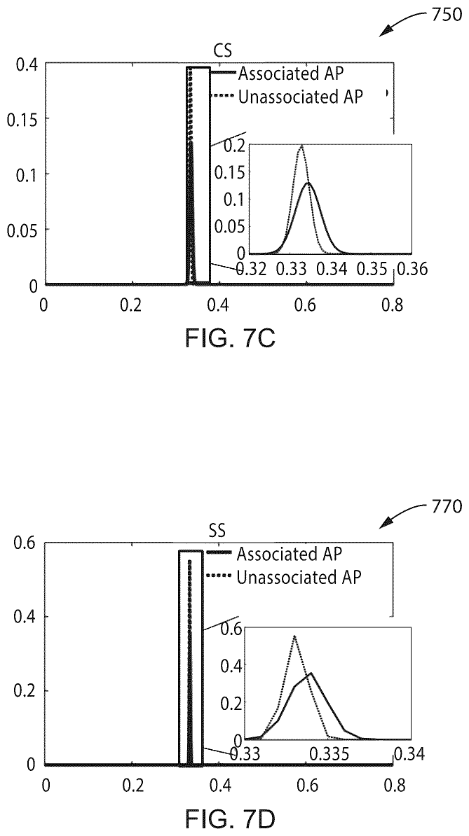

FIG. 7A through FIG. 7D illustrate distribution of associated and unassociated AP of CMA and baselines. FIG. 7A depicts 710 associated AP and unassociated AP for CMA. FIG. 7B depicts 730 associated AP and unassociated AP for MCC. FIG. 7C depicts 750 associated AP and unassociated AP for CS. FIG. 7D depicts 770 associated AP and unassociated AP for SS.

Accordingly, the present disclosure demonstrates the distribution of associated and Unassociated Probability (unAP) to further analyze the performance of CMA and baselines. For the baselines, the SoftMax function was adopted to convert the metric values between two cross-modal segments to association probability (Equation 6). These figures depict the AP distribution of CMA and baselines. It can be observed from these graphs that the distribution of associated and unAP of CMA has less overlapping than the baselines, which indicates the estimated AP value of CMA is more separable.

### 4.2. Impacts of Data: Activity Category and Association Levels

One potential factor that may impact the association performance is the type of activities since the association level varies for different activities. For some activities, the motion measured by the wearable also directly induces structural vibration. For example, when people cut food, their wrist motion (measured by the IMU) directly causes the knife to impact the cutting board (measured by vibration sensors). On the other hand, for some activities, the motion measured by the wearable does not directly associate with the structural vibration. For example, vacuuming the floor causes the floor to vibration due to motor vibration, which does not directly indirectly cause structural vibration via wrist motions. Therefore, in at least one embodiment multiple (e.g., nine, but this is not intended to be limiting as any number of known activities may be used) types of activities were categorized into three levels of association, direct, indirect, and semi-direct, as illustrated in Table 2.

### 4.2.1. Activity Category Combinations

To demonstrate the robustness of CMA over the types of activities with different association levels, four pairs of segments were randomly selected out of subsets of pairs with different types of activities—direct associated activities, indirect associated activities, semi-direct associated activities, and mixed activities. Then the same testing procedure as described in Section 3.2, above was performed.

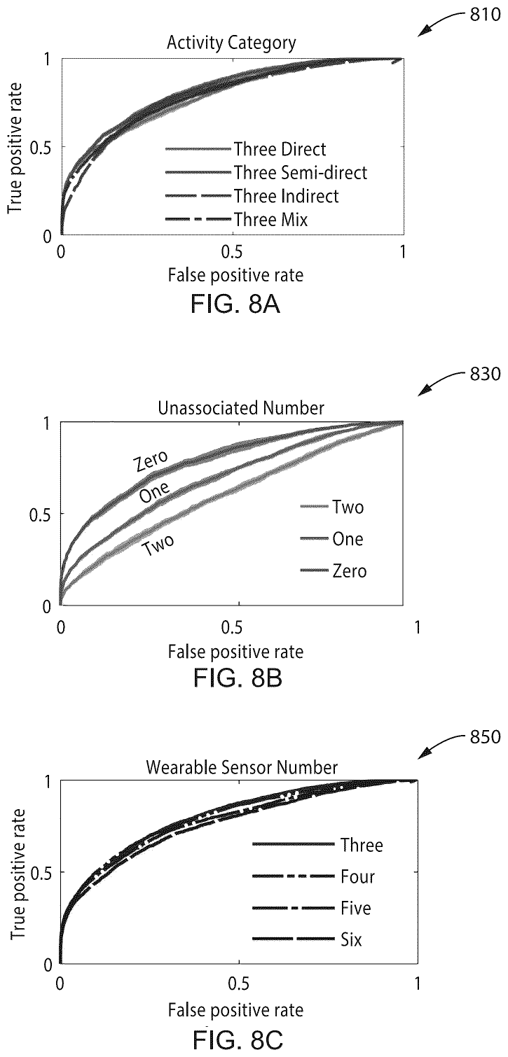

FIG. 8A through FIG. 8C illustrate ROC curves of CMA in the public dataset analysis showing the performance of CMA for impact of activity category, unassociated number, and wearable sensor number, respectively.

In FIG. 8A is depicted 810 the average ROC curve on 10 repetition experiments. The average AUC value of CMA is 0.79 (direct), 0.82 (semi-direct), 0.79 (indirect), 0.80 (mix). Three baselines depict overall lower than 0.7 AUC values. CMA achieves the best performance in all activity category combinations. Furthermore, CMA demonstrates robustness over different activity categories, while the baselines have inconsistent performance with the AUC value varying between 0.6 and 0.7.

### 4.2.2. Unassociated Combinations

To better understand how CMA performs in the real scenario, the situation was further evaluated in the case when some of the vibration signals are generated by occupants without an IMU sensor. By way of example and not limitation, three pairs of signals (VibSigᵢ and IMUSigⱼ) were randomly selected from the full set of pairs (1048) and the scenario was investigated for 0 or 1 or 2 of them i≠j and the rest i=j. Then the same experimental procedure described in Section 3.2 above was followed in comparing the AUC values when there are different numbers of unassociated pairs among the three.

In FIG. 8B is depicted 830 the average ROC curve of CMA on 10 repetition experiments. Overall, when the number of unassociated pairs increases, the AUC value decreases. This could be because the prediction of the unassociated infrastructural signal is done with multiple IMU signals equally not associated, which results in similar APs that is not efficient for distinguishing the association relationship. When there is one unassociated signal pair, CMA achieves an AUC value over 0.7, while the baselines only achieve 0.57, 0.56, and 0.58, respectively (random selection's AUC value is 0.5). CMA also achieves the best performance in relation to the baselines.

### 4.2.3. Wearable Sensor Number

To better understand the scalability of CMA, a further evaluation of CMA was performed when the number of wearable devices N was larger than 3. The first step in this test, was randomly selecting multiple (e.g., three) pairs of signal segments from the full set of pairs. Furthermore, extra numbers of IMUSig were randomly selected and CMA was applied to associate M=3 number of VibSig and N number of IMUSig, where N=3, 4, 5, 6. Then by way of example and not limitation, the same experimental process was followed as described above in Section 3.2.

In FIG. 8C is depicted 850 the average ROC curve of CMA. When the number of wearable sensors N increases from 3 (the same as the number of vibration sensors M) to 6, the average AUC values decrease slightly (≤0.05) with the number of wearable increasing. This is because the difficulty of finding the associated IMU segment increases when the number of IMU segments N increase. In summary, CMA also works in scenarios with more than three people.

### 4.3. Impacts of CMA Configuration

The present disclosure further explores the impact of the hyper-parameter configuration of CMA on performance. As introduced in Section 2.2 above, CMA contains three hyper-parameters: (1) hidden layer number L, (2) receptive field F (adjusted by kernel size K), and (3) input AU length η. The default values for these hyper-parameters are shown in Table 3. Multiple (e.g., three pairs) of segments were randomly selected from the full set (1048 pairs) and tests conducted with the procedure introduced in Section 3.2 above with varying AD-TCN hyper-parameters.

### 4.3.1. Hidden Layer Number L

Hidden layer number directly impacts the complexity of the neural network. Therefore, the disclosure also investigates the manner in which the model acts at different levels of complexity for the cross-modal time series prediction.

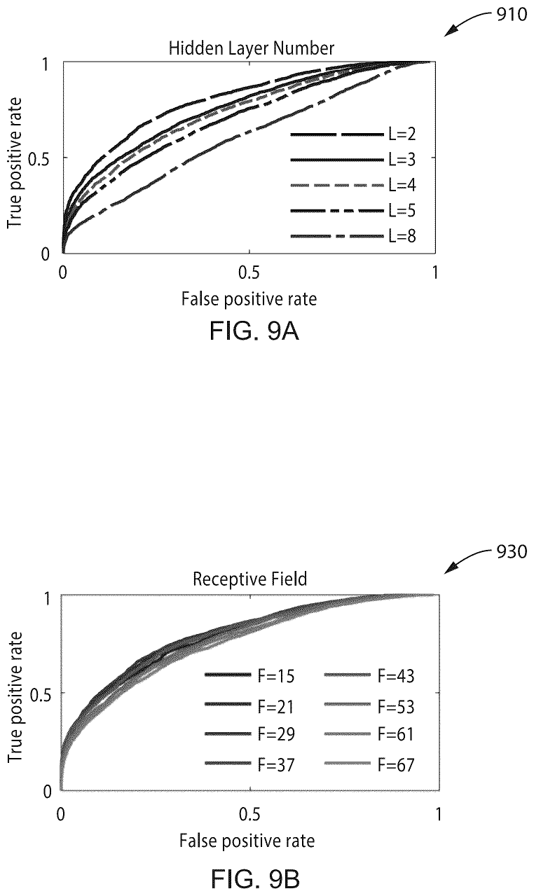

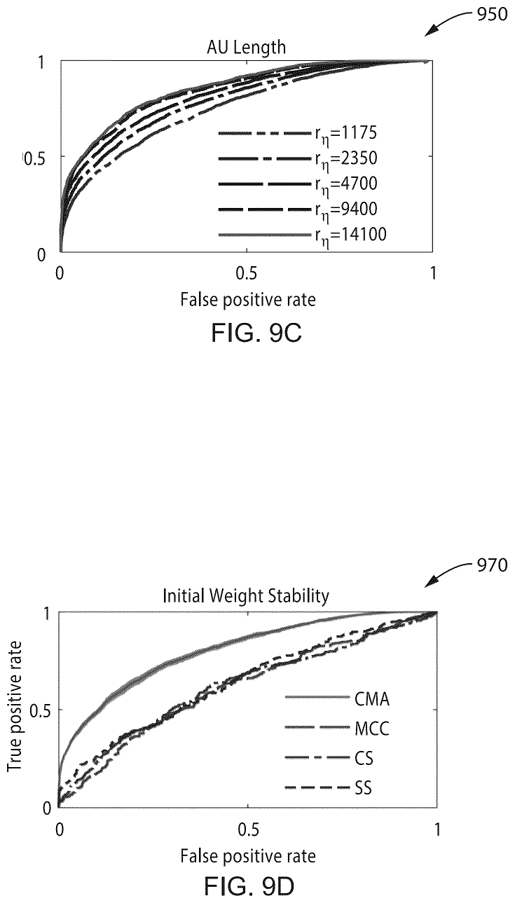

FIG. 9A through FIG. 9D illustrate the impact of CMA configurations and the repeatability of CMA, as depicted under the different configurations of hidden layer number, receptive field, and AU length in FIG. 9A through FIG. 9C, respectively, while FIG. 9D shows the ROC curve of CMA and baseline methods when CMA is repeated 10 times on the same test set.

In this testing, L was increased from 2 to 8 which resulted in the average ROC curve of CMA shown in FIG. 9A. The average AUC value of each configuration are 0.81, 0.76, 0.74, 0.071, and 0.61, respectively. It was observed that CMA achieves the highest AUC value when L is set to 2. This result indicates that a shallow architecture is more suited for the cross-modal association task. This may arise because the association discovery task is fundamentally a binary classification task, and the model can be presented sufficiently with a simple network architecture. A large L value may cause the network to overfit. When the overfit occurs, the network cannot generalize to test data, hence it is not able to make accurate predictions. Under this circumstance, the calculated association score is not reliable for association discovery.

### 4.3.2. Receptive Field F

The receptive field F is determined by both the hidden layer number L and the causal convolutional layer's kernel size K as F=(K−1)·L+1. It describes how ‘far’ the model can ‘see’ to predict the current samples. For example, FIG. 4B shows an example of a causal convolutional layer with a kernel size K=2. If layer number L=2, then receptive field F=(2−1)·2+1=3.

In FIG. 9B is shown the average ROC curve in different receptive field configurations. When F increases, the average AUC value first increases then decreases (0.79, 0.80, 0.81, 0.80, 0.79, 0.78, 0.76, and 0.75 for F from 15 to 67). CMA demonstrates a stable performance and achieves the highest average AUC value when F is 29. One explanation for why CMA achieves the highest AUC with F=29 is that the time duration for 29 samples is approximately 0.1 second, which is approximately the duration for an arm motion to cause an impulsive vibration signal. Therefore, this amount of ‘history’ data is most helpful for the prediction of current sample values.

### 4.3.3. Input AU Length η

The input AU length η determines how much data is available to determine AP and the association relationship. Intuitively, the longer the observation data is, the more accurate the time-series prediction model is, and hence the network parameter that describes the association relationship is more accurate.

In FIG. 9C is shown the average ROC curve of CMA when the input AU length η varies from 1175 (τ=5 seconds) to 14100 (τ=60 seconds). With the increase of η, the performance of all evaluated methods increases. The value of η was selected taking into account the trade-off between the prediction accuracy and data practicality. Since the assumption is that the signal association within q is invariant, it means that the higher the η value, the more unlikely the assumption holds. By way of example and not limitation, for the public dataset, the default value was considered as η of 2350 (r=10) because the duration of activity from the public dataset is in the range of 10 to 15 seconds.

### 4.3.4. AD-TCN Initial Weight Stability

The initial weight assignment can directly impact the neural network model and its performance. Therefore, the present disclosure also investigates the repeatability of AD-TCN with different random initial weights. Three pairs of segments were randomly selected out of the full set, and AD-TCN training conducted with different initial randomization 10 times. By way of example and not limitation, this random selection was repeated 110 times to avoid sampling bias.

In FIG. 9D is shown the average ROC curves of CMA and baselines when AD-TCN is trained on the same dataset 10 times with different random initial weights. The CMA line shows the average false positive rate and true positive rate, and the area around the CMA line shows the standard deviation of 10 times of weight initialization. CMA demonstrates a stable performance when the weights of the neural network module is initialized differently, as compared to the results for Maximum Cross-Correlation (MCC), Cosine Similarity (CS), and Surface Similarity (SS) as shown in the figure.

### 4.4. Robustness in Uncontrolled Deployment

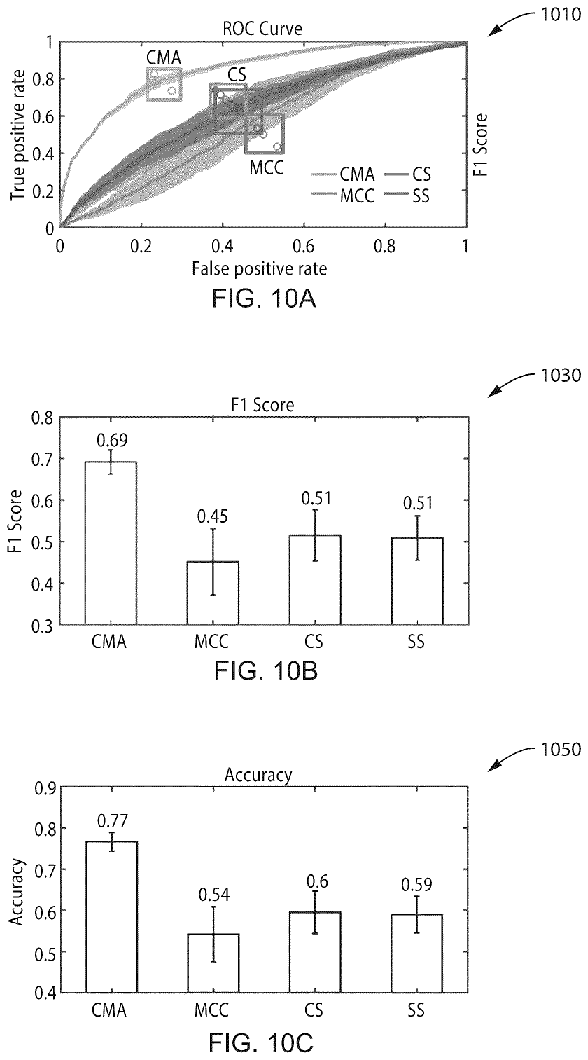

FIG. 10A through FIG. 10C illustrate example results of overall performance with the uncontrolled dataset. FIG. 10A shows the average ROC curve and the standard deviation (i.e., width of the curve) of false positive rate and true positive rate in a dataset including different houses. The circles on the curves indicate the false positive rate and true positive rate when CMA operates with the selected threshold. In FIGS. 10B and 10C are depicted the F1 score and accuracy under the selected association threshold, respectively.

In FIG. 10A, the graph 1010 depicts an average ROC curve and the standard deviation of false positive rate and true positive rate of CMA and baselines is shown for the five houses dataset. The performance of CMA is observed to improve over the baselines and the false positive rate and true positive rate is more stable. The average AUC value of CMA, and baselines are 0.85, 0.64 (MCC), 0.56 (CS), and 0.64 (SS), respectively. The AUC value of CMA achieves 0.85, which is up to 37% improvement compared to the baselines.

The circle marks in FIG. 10A indicate the false positive rate and true positive rate under the selected association threshold (introduced in Section 3.5 above).

The bar charts 1030, 1050, of FIG. 10B and FIG. 10C, respectively, demonstrate F1 score and accuracy. The average F1 score of CMA and baselines achieve 0.69, 0.45 (MCC), 0.51 (CS), and 0.51 (SS), respectively. The F1 score of CMA achieves 0.69, which is up to a 53% improvement compared to the baselines. The average accuracy of CMA and baselines achieve 0.77, 0.54 (MCC), 0.50 (CS), and 0.59 (SS), respectively. The accuracy of CMA achieves 0.77, which is up to a 43% improvement compared to the baselines.

It was also observed that compared with the performance in the public dataset, the performance of CMA in the uncontrolled dataset is 0.05% better (AUC value 0.8 vs. 0.85, F1 score 0.64 vs. 0.69, accuracy 0.72 vs. 0.77). This may have arisen because in the uncontrolled dataset, the three human subjects are more likely to conduct different types of activity at the same time than in the public dataset. Finding the association relationship from the same type of activity is more difficult since the IMU segments of the same type of activity are more similar to each other.

### 4.5. Use Case Performance

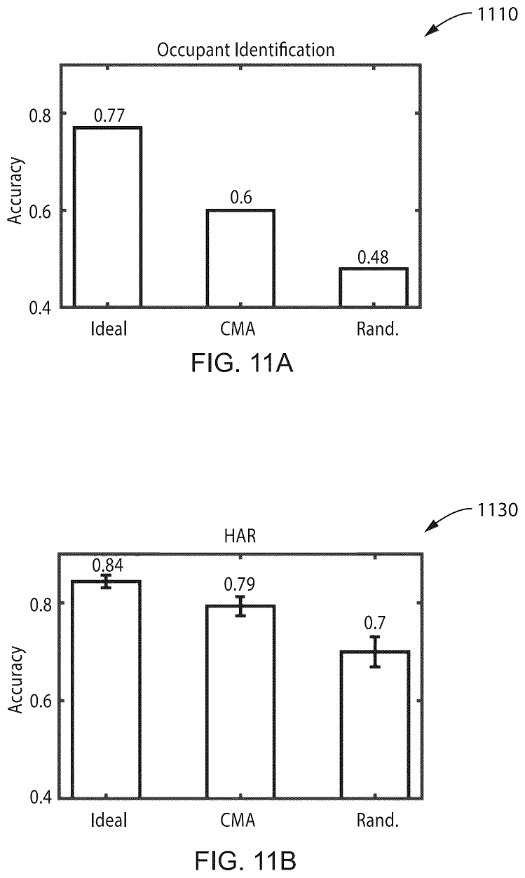

FIG. 11A and FIG. 11B illustrate 1110, 1130 the accuracy of CMA compared with the baselines for two use cases. The bars represent Ideal association (ground truth), CMA association, and Random association (baseline), respectively. It was observed that with the association provided by CMA, both use cases demonstrate an improvement in accuracy compared to the baseline. For occupant identification, the system achieves a 12% accuracy increase with the pseudo label provided by CMA without any manual label. For HAR, CMA achieves approximate 10% accuracy improvement compared to without the association information, and it is only 5% lower than the accuracy with ideal association. Such improvement is promising, considering that it is made with leveraging the pervasive wearable IMU data, and without requirements of any label data.

### 5. Discussion

### 5.1. Temporal Overlapping and Activity Segmentation

The focus has been on the cross-modal segment-level association problem with the assumption of no temporal signal overlapping of multiple sources at one structural vibration sensor. If one structural vibration sensor captures overlapped signals from multiple activities, the implicit shared context can be learned for association purposes will be more constrained than what has been investigated in this work and therefore more challenging. In at least one embodiment, either leveraging hierarchical temporal information over different time resolutions or combining frequency domain analysis to tackle the signal temporal overlapping challenge is expected to provide additional benefits.

Activity segmentation is another important aspect of indoor occupant sensing. By way of example and not intended to be limiting, the a lumping algorithm may be used. The uncontrolled experimental results inherited the segmentation error from the lumping algorithm. It should be appreciated that beneficial embodiments may be provided by incorporating other activity segmentation schemes. Furthermore, beneficial embodiments may be provided which jointly conduct the separation and segmentation with CMA to further improve robustness.

### 5.2. Association-Aware Multimodal Learning

The segment-level association learned for each segment can further be used as learned information to enhance the existing multimodal learning. For example, the association can be used as a dynamic sensor selection criteria to allow the inference models to adapt to input channels, as well as a regularization to reduce the chance of learning a spurious relationship between input channels and data labels. For graph neural network-based models, this association may be used as the prior knowledge to establish the graph, ensuring a more efficient and robust inference.

### 5.3. Generalizing Modality

CMA was evaluated with the combination of structural vibration sensing and wearable on-wrist IMU sensing. CMA is designed for general time series sensing modalities, and embodiments can be implemented based on the present disclosure which capitalize on using additional modalities (e.g., acoustic, event camera, electricity load, physiological sensors) in combination to further understand its limitation and ability to be generalized. For the high-dimension sensing data, an encoder can be built to convert the high-dimension data to one-dimension sequences, such as data2vec.

Alternatively, association learning is more challenging for modalities with a latent and longer dependency. For example, when the occupant turns on the heater, the indoor temperature becomes warmer, and the occupant's heart rate will slowly go higher. In this case, the association between the electricity load sensor and physiological sensors (heart rate monitor) data is latent and potentially requires a new framework for association learning.

### 5.4. Computational Requirements of CMA

It was found in the experiments performed on at least one embodiment of the present disclosure, that the time required to perform CMA for one AU was around 10 seconds on an Apple MacBook Pro 2022 using CPU only. The present work focused on providing a data-driven method to discover the association relationship between two modalities without the requirements of label data. However, the time required can be decreased by optimizing multiple factors, such as the code implementation framework, and adopting parallel computing. The current computation is on the server side, although it should be appreciated that other embodiments can be implemented which offload the computation to nearby devices with an event-driven design on the embedded platform side.

### 6. Conclusion

A CMA process as a cross-modal signal segment association scheme between wearable and structural vibration sensors is described. Also introduced is AD-TCN, a TCN-based framework, to determine the amount of shared context between signal segments from two modalities. After training the network, the association probability is determined based on the weights of the trained AD-TCN, and determine the pairwise segment association. CMA was evaluated using a public multimodal dataset for systematic evaluation, and a continuous uncontrolled dataset collected to provide for robustness evaluation. CMA was found to achieve up to a 37% AUC value, 53% F1 score, and 43% accuracy improvement compared to baselines.

### 7. General Scope of Embodiments

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

An apparatus for cross-modal association between wearable and structural vibration signal segments for indoor occupant sensing, comprising: (a) a multimodal signal alignment module configured for receiving inputs from at least one structural vibration sensor and multiple wearable sensors, each comprising an inertial measurement unit (IMU); (b) an association discovery temporal convolutional network (AD-TCN) having an association score layer, temporal convolution layer, and a pointwise convolution layer; and (c) an pairwise association determination module; (d) wherein said modules in combination are configured to estimate association relationship between a vibration sensor and a wearable sensor.

An apparatus for cross-modal association between wearable and structural vibration signal segments for indoor occupant sensing, comprising: (a) a multimodal signal alignment module configured for receiving sensor inputs of different modalities as a combination of a structural vibration sensor associated with a physical structure, and a wearable sensor having wearable sensor inputs associated with a user; (b) wherein a sampling rate and timestamps of the sensor inputs are aligned in said multimodal signal alignment module; (c) wherein infrastructure events are detected and segmented as segment-level associated cross modalities between the vibration sensor inputs and the wearable sensor inputs within said multimodal signal alignment module; (d) an association discovery temporal convolutional network (AD-TCN) module configured for determining an extent of shared context between signal segments from different modalities, comprising: an association score layer coupled to a plurality of temporal convolution network (TCN) blocks, with each of the plurality of TCN blocks coupled to a pointwise convolution layer which performs infrastructure signal prediction over a period of time and outputs wearable and vibration segment values; (e) wherein said wearable and vibration segment values are utilized to predict the current time step value of the vibration segment, and train the convolution network model to determine association probability between signal segments from these two modalities based on the weights of the trained AD-TCN, wherein association probability reflect contributions of one signal segment for predicting the other signal segment; and (f) a pairwise association determination module receives output from the AD-TCN and estimates association probabilities in response to determining association distance as a measurement of the association relationship which is then converted to a common measurement between multi-modal sensing, to which association thresholding is performed to generate a pairwise association output indicating whether there is sufficient cross-modal association between the structural vibration sensor associated with a physical structure, and the wearable sensor associated with a given user to consider both sensor inputs to be indicative of the same event.

A method of determining cross-modal association between wearable and structural vibration signal segments for indoor occupant sensing, comprising: (a) performing multimodal signal alignment module configured for receiving sensor inputs of different modalities as a combination of a structural vibration sensor associated with a physical structure, and a wearable sensor having wearable sensor inputs associated with a user; and in which a sampling rate and timestamps of the sensor inputs are aligned in said multimodal signal alignment module; (b) detecting infrastructure events and segmenting sensor inputs as segment-level associated cross modalities between the vibration sensor inputs and the wearable sensor inputs within said multimodal signal alignment module; (c) performing association discovery in a temporal convolutional network (AD-TCN) configured for determining an extent of shared context between signal segments from different modalities, comprising: an association score layer coupled to a plurality of temporal convolution network (TCN) blocks, with each of the plurality of TCN blocks coupled to a pointwise convolution layer which performs infrastructure signal prediction over a period of time and outputs wearable and vibration segment values; (d) wherein said wearable and vibration segment values are utilized to predict the current time step value of the vibration segment, and train the convolution network to determine association probability between signal segments from these two modalities based on the weights of the trained AD-TCN, wherein association probability reflect contributions of one signal segment for predicting the other signal segment; and (e) performing a pairwise association determination in which output from the association discovery TCN is used in estimating association probabilities based on determining association distance as a measurement of the association relationship which is then converted to a common measurement between multi-modal sensing, to which association thresholding is performed to generate a pairwise association output indicating whether there is sufficient cross-modal association between the structural vibration sensor associated with a physical structure, and the wearable sensor associated with a given user to consider both sensor inputs to be indicative of the same event.

An apparatus for cross-modal association between wearable and structural vibration signal segments for indoor occupant sensing, comprising: (a) a multimodal signal alignment module; (b) an association discovery temporal convolutional network (AD-TCN) module; (c) an association probability estimation module; (d) wherein said modules in combination are configured to estimate association relationship between a vibration sensor and a wearable sensor.

The apparatus, system or method of any preceding or subsequent implementation, wherein the vibration sensor is associated with a physical structure; wherein the wearable sensor is associated with a user; and wherein the modules estimate association between vibration sensor signals and a user who induces the vibration sensor signals interior to the structure.

The apparatus, system or method of any preceding or subsequent implementation, wherein the multimodal signal alignment module comprises: a sampling rate alignment layer, a timestamp alignment layer, and an infrastructural event detection and segmentation layer.

The apparatus, system or method of any preceding or subsequent implementation, wherein the AD-TCN module comprises: an association score layer, a temporal convolution network layer; and a pointwise convolutional layer.

The apparatus, system or method of any preceding or subsequent implementation, wherein the association probability estimation layer comprises: an association distance calculation layer, a SoftMax layer; and an association thresholding layer.

The apparatus, system or method of any preceding or subsequent implementation, wherein the multimodal signal alignment module comprises: (a) a non-transitory memory storing instructions; and (b) a processor configured to access the non-transitory memory and to execute the instructions to at least perform: (b)(i) sampling rate alignment by acquiring sampling rate from available sensors, identifying the lowest sampling rate from available sensors, and down sampling all the other sensors' sampling rate to this lowest sampling rate; (b)(ii) sample-level timestamp generation by using the timestamp of the sensor data file to calculate the timestamp of each sample by interpolation; (b)(iii) infrastructure sensor event detection by applying a sliding window on the raw data, calculating signal energy for each windowed signal, and if the window's signal energy is larger than a threshold then marking the window as (part of) an event, wherein consecutive windows that are marked as an event are considered the same event; and (b)(iv) activity segmentation by calculating the interval of two consecutive different events as the later event's starting time minus earlier event's ending time, wherein if this interval is smaller than a threshold then these two events are marked as the same activity, and wherein if this interval is not smaller than the threshold then marking the later event as a new activity.

The apparatus, system or method of any preceding or subsequent implementation, wherein the AD-TCN module has non-transitory memory storing instructions; and a processor configured to access the non-transitory memory and to execute the instructions comprising: (a) initializing all nodes of the association score layer of the AD-TCN convolution network with a weight value, so that each input equally contributes to structural vibration signal prediction, and with weight values being updated during training through a gradient descent process; (b) training an AD-TCN for each structural vibration sensor input and N number of wearable sensor inputs having multiple channels C associated with each axis of the inertial measurement unit (IMU) of that wearable sensor, wherein N*C+1 association scores are initiated as random values; (c) association score layer determination is performed by multiplying the association score for each channel and the corresponding channel data; (d) executing a temporal convolution network residual block by sending the association score layer output for each channel to a TCN residual block, wherein output is generated for each channel; (e) executing a pointwise convolution layer by calculating a weighted sum with all channels' feature extracted by the TCN residual blocks, and wherein the output is the prediction of the infrastructure sensor data; (f) performing loss calculation wherein mean-square-error between the predicted infrastructure sensor data and the measured infrastructure sensor data is calculated as the loss; (g) performing a gradient descent determination to update parameters, by using a gradient descent algorithm and back propagation to update the parameters in the network by minimizing the loss; and (h) repeating (c) to (g) until the stop conditions are satisfied.

The apparatus, system or method of any preceding or subsequent implementation, wherein the association probability estimation layer comprises non-transitory memory storing instructions; and a processor configured to access the non-transitory memory and to execute the instructions comprising: (a) performing association divergence calculations by calculating the square root of the sum of the association scores (C values) from one wearable sensor as the association divergence of this wearable sensor; (b) performing association probability calculation wherein the association probability is the SoftMax result of the association divergence of all wearable sensors; and (c) performing a threshold-based association determination wherein if the association probability of a wearable sensor is larger than a threshold, the wearable sensor is considered to be in association with the infrastructure sensor.

The apparatus, system or method of any preceding or subsequent implementation, wherein AD-TCN training is performed using stochastic gradient descent is utilized with adaptive moment estimation as an optimizer which provides iterative optimization for minimizing the loss function during the training of neural networks

The apparatus, system or method of any preceding or subsequent implementation, wherein said indoor occupancy sensing enables many smart building applications to associate between vibration sensing modalities and wearable sensors.

The apparatus, system or method of any preceding or subsequent implementation, wherein said smart building applications are selected from a group of smart buildings applications consisting of home, care facilities, hospice, retail stores, and business operations.

The apparatus, system or method of any preceding or subsequent implementation, wherein the vibration sensor is associated with a physical structure; wherein the wearable sensor is associated with a person; and wherein the modules estimate association between vibration sensor signals and a person who induces the vibration sensor signals interior to the structure.

The apparatus, system or method of any preceding or subsequent implementation, wherein the multimodal signal alignment module comprises: (i) a sampling rate alignment layer; (ii) a timestamp alignment layer; and (iii) an infrastructural event detection and segmentation layer.

The apparatus, system or method of any preceding or subsequent implementation, wherein the association discovery temporal convolutional network (AD-TCN) module comprises: (i) an association score layer; (ii) a temporal convolution network layer; and (iii) a pointwise convolutional layer.

The apparatus, system or method of any preceding or subsequent implementation, wherein the association probability estimation layer comprises: (i) an association distance calculation layer; (ii) a SoftMax layer; and (iii) an association thresholding layer.

The apparatus, system or method of any preceding or subsequent implementation, wherein the multimodal signal alignment module comprises: (i) a non-transitory memory storing instructions; and (ii) a processor configured to access the non-transitory memory and to execute the instructions to at least perform: (A) sampling rate alignment by acquiring sampling rate from available sensors, identifying the lowest sampling rate from available sensors, and down sampling all the other sensors' sampling rate to this lowest sampling rate; (B) sample-level timestamp generation by using the timestamp of the sensor data file to calculate the timestamp of each sample by interpolation; (C) infrastructure sensor event detection by applying a sliding window on the raw data, calculating signal energy for each windowed signal, and if the window's signal energy is larger than a threshold then marking the window as (part of) an event, wherein consecutive windows that are marked as an event are considered the same event; and (D) activity segmentation by calculating the interval of two consecutive different events as the later event's starting time minus earlier event's ending time, wherein if this interval is smaller than a threshold then these two events are marked as the same activity, and wherein if this interval is not smaller than the threshold then marking the later event as a new activity.

The apparatus, system or method of any preceding or subsequent implementation, wherein the association discovery temporal convolutional network (AD-TCN) module comprises: (i) non-transitory memory storing instructions; and (ii) a processor configured to access the non-transitory memory and to execute the instructions to at least perform: (B) initiation, wherein for one infrastructure (vibration) sensor and N wearable (IMU) sensor, the association score layer have N*C+1 scores, with C the number of axes for IMU sensor, scores corresponding to all sensors, wherein each sensor's each axis series data is referred to as a channel, and wherein these N*C+1 association scores are initiated as random values; (ii) association score layer computation by multiplying the association score for each channel and the corresponding channel data; (iii) a temporal convolution network residual block by sending the association score layer output for each channel to a TCN residual block, wherein the output is features for each channel data; (iv) a pointwise convolution layer by calculating a weighted sum with all channels' feature extracted by the TCN residual blocks, and wherein the output is the prediction of the infrastructure sensor data; (v) loss calculation wherein the mean square error between the predicted infrastructure sensor data and the observed (measured) infrastructure sensor data is calculated as the loss; (vi) gradient descent to update parameters, by using a gradient descent algorithm and back propagation to update the parameters in the network by minimizing the loss; and (vii) repeating (ii) to (vi) until the stop conditions are satisfied.

The apparatus, system or method of any preceding or subsequent implementation, wherein the association probability estimation layer comprises: (i) non-transitory memory storing instructions; and (ii) a processor configured to access the non-transitory memory and to execute the instructions to at least perform: (A) association divergence calculation by calculating the square root of the sum of the association scores (C values) from one wearable sensor as the association divergence of this wearable sensor; (B) association probability calculation wherein the association probability is the SoftMax result of the association divergence of all wearable sensors; and (C) threshold-based association determination wherein if the association probability of a wearable sensor is larger than a threshold, the wearable sensor is considered to be in association with the infrastructure sensor.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to +5%, less than or equal to +4%, less than or equal to +3%, less than or equal to ±2%, less than or equal to ±1%, less than or equal to ±0.5%, less than or equal to +0.1%, or less than or equal to ±0.05%. For example, “substantially” aligned can refer to a range of angular variation of less than or equal to +10°, such as less than or equal to 5°, less than or equal to 4°, less than or equal to 3°, less than or equal to 2°, less than or equal to 1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

TABLE 1
Signal similarity metrics for signals X, Y of length l

| Metric | Equation |
|---|---|
| MCC | $MCC ( X , Y ) = {max}_{k = 0 , … , l} \frac{{\sum }_{i = 1}^{l} {x}_{i} \cdot {y}_{i + k}}{\sqrt{{\sum }_{i = 1}^{l} {x}_{i}^{2}} \cdot \sqrt{{\sum }_{i = 1}^{l} {y}_{i}^{2}}}$ |
| Cosine Similarity | $CS ( X , Y ) = \frac{{\sum }_{i = 1}^{l} {x}_{i} \cdot {y}_{i}}{\sqrt{{\sum }_{i = 1}^{l} {x}_{i}^{2}} \cdot \sqrt{{\sum }_{i = 1}^{l} {y}_{i}^{2}}}$ |
| Surface Similarity | $SS ( X , Y ) = \frac{\sqrt{{\sum }_{i = 1}^{l} {( {x}_{i} - {y}_{i} )}^{2}}}{\sqrt{{\sum }_{i = 1}^{l} {x}_{i}^{2}} + \sqrt{{\sum }_{i = 1}^{l} {y}_{i}^{2}}}$ |

TABLE 2
Types of activities and cross-modal association levels

| Assoc. Levels | Activities |
|---|---|
| direct | cutting food, stir-fry, open/close drawer |
| indirect | keyboard typing, handwriting, vacuuming |
| semi-direct | using mouse, wiping countertop, sweeping |

TABLE 3
CMA Hyper-parameters

| Parameters | Default | Controlled Experiment Values |
|---|---|---|
| L | 2 | 2, 3, 4, 5, 8 |
| F | 29 | 15, 21, 29, 37, 43, 53, 61, 67 |

What is claimed is:

1. An apparatus for cross-modal association between wearable and structural vibration signal segments for indoor occupant sensing, comprising:
a multimodal signal alignment module configured for receiving inputs from at least one structural vibration sensor and multiple wearable sensors, each comprising an inertial measurement unit (IMU);
an association discovery temporal convolutional network (AD-TCN) having an association score layer, temporal convolution layer, and a pointwise convolution layer; and
an pairwise association determination module;
wherein said modules in combination are configured to estimate association relationship between a vibration sensor and a wearable sensor.

2. The apparatus of claim 1, wherein the vibration sensor is associated with a physical structure; wherein the wearable sensor is associated with a user; and wherein the modules estimate association between vibration sensor signals and a user who induces the vibration sensor signals interior to the structure.

3. The apparatus of claim 1, wherein the multimodal signal alignment module comprises: a sampling rate alignment layer, a timestamp alignment layer, and an infrastructural event detection and segmentation layer.

4. The apparatus of claim 1, wherein the AD-TCN module comprises: an association score layer, a temporal convolution network layer; and a pointwise convolutional layer.

5. The apparatus of claim 1, wherein the association probability estimation layer comprises: an association distance calculation layer, a SoftMax layer; and an association thresholding layer.

6. The apparatus of claim 1, wherein the multimodal signal alignment module has a non-transitory memory storing instructions and a processor configured to access the non-transitory memory and to execute the instructions comprising:
(a) performing sampling rate alignment by acquiring sampling rate from available sensors, identifying the lowest sampling rate from available sensors, and down sampling all the other sensors' sampling rate to this lowest sampling rate;
(b) performing sample-level timestamp generation by using the timestamp of the sensor data file to calculate the timestamp of each sample by interpolation;
(c) performing infrastructure sensor event detection by applying a sliding window on the raw data, calculating signal energy for each windowed signal, and if the window's signal energy is larger than a threshold then marking the window as (part of) an event, wherein consecutive windows that are marked as an event are considered the same event; and
(d) activity segmentation by calculating the interval of two consecutive different events as the later event's starting time minus earlier event's ending time, wherein if this interval is smaller than a threshold then these two events are marked as the same activity, and wherein if this interval is not smaller than the threshold then marking the later event as a new activity.

7. The apparatus of claim 1, wherein the AD-TCN module has a non-transitory memory storing instructions and a processor configured to access the non-transitory memory and to execute the instructions comprising:
(a) initializing all nodes of the association score layer of the AD-TCN convolution network with a weight value, so that each input equally contributes to structural vibration signal prediction, and with weight values being updated during training through a gradient descent process;
(b) training an AD-TCN for each structural vibration sensor input and N number of wearable sensor inputs having multiple channels C associated with each axis of the inertial measurement unit (IMU) of that wearable sensor, wherein N*C+1 association scores are initiated as random values;
(c) association score layer determination is performed by multiplying the association score for each channel and the corresponding channel data;
(d) executing a temporal convolution network residual block by sending the association score layer output for each channel to a TCN residual block, wherein output is generated for each channel;
(e) executing a pointwise convolution layer by calculating a weighted sum with all channels' feature extracted by the TCN residual blocks, and wherein the output is the prediction of the infrastructure sensor data;
(f) performing loss calculation wherein mean-square-error between the predicted infrastructure sensor data and the measured infrastructure sensor data is calculated as the loss;
(g) performing a gradient descent determination to update parameters, by using a gradient descent algorithm and back propagation to update the parameters in the network by minimizing the loss; and
(h) repeating (c) to (g) until the stop conditions are satisfied.

8. The apparatus of claim 1, wherein the association probability estimation layer has non-transitory memory storing instructions and a processor configured to access the non-transitory memory and to execute the instructions comprising:
(a) performing association divergence calculations by calculating the square root of the sum of the association scores (C values) from one wearable sensor as the association divergence of this wearable sensor;
(b) performing association probability calculation wherein the association probability is the SoftMax result of the association divergence of all wearable sensors; and
(c) performing a threshold-based association determination wherein if the association probability of a wearable sensor is larger than a threshold, the wearable sensor is considered to be in association with the infrastructure sensor.

9. The apparatus of claim 1, wherein AD-TCN training is performed using stochastic gradient descent is utilized with adaptive moment estimation as an optimizer which provides iterative optimization for minimizing the loss function during the training of neural networks.

10. The apparatus of claim 1, wherein said indoor occupancy sensing enables many smart building applications to associate between vibration sensing modalities and wearable sensors.

11. The apparatus of claim 10, wherein said smart building applications are selected from a group of smart buildings applications consisting of home, care facilities, hospice, retail stores, and business operations.

12. An apparatus for cross-modal association between wearable and structural vibration signal segments for indoor occupant sensing, comprising:
(a) a multimodal signal alignment module configured for receiving sensor inputs of different modalities as a combination of a structural vibration sensor associated with a physical structure, and a wearable sensor having wearable sensor inputs associated with a user;
(b) wherein a sampling rate and timestamps of the sensor inputs are aligned in said multimodal signal alignment module;
(c) wherein infrastructure events are detected and segmented as segment-level associated cross modalities between the vibration sensor inputs and the wearable sensor inputs within said multimodal signal alignment module;
(d) an association discovery temporal convolutional network (AD-TCN) module configured for determining an extent of shared context between signal segments from different modalities, comprising: an association score layer coupled to a plurality of temporal convolution network (TCN) blocks, with each of the plurality of TCN blocks coupled to a pointwise convolution layer which performs infrastructure signal prediction over a period of time and outputs wearable and vibration segment values;
(e) wherein said wearable and vibration segment values are utilized to predict the current time step value of the vibration segment, and train the convolution network model to determine association probability between signal segments from these two modalities based on the weights of the trained AD-TCN, wherein association probability reflect contributions of one signal segment for predicting the other signal segment; and
(f) a pairwise association determination module receives output from the AD-TCN and estimates association probabilities in response to determining association distance as a measurement of the association relationship which is then converted to a common measurement between multi-modal sensing, to which association thresholding is performed to generate a pairwise association output indicating whether there is sufficient cross-modal association between the structural vibration sensor associated with a physical structure, and the wearable sensor associated with a given user to consider both sensor inputs to be indicative of the same event.

13. The apparatus of claim 12, wherein the vibration sensor is associated with a physical structure and the wearable sensor is associated with a user; and wherein the modules estimate association between vibration sensor signals and a user who induces the vibration sensor signals interior to the structure.

14. The apparatus of claim 12, wherein the multimodal signal alignment module comprises: a sampling rate alignment layer, a timestamp alignment layer, and an infrastructural event detection and segmentation layer.

15. The apparatus of claim 12, wherein the AD-TCN module comprises: an association score layer, a temporal convolution network layer, and a pointwise convolutional layer.

16. The apparatus of claim 12, wherein the association probability estimation layer comprises: an association distance calculation layer, a SoftMax layer; and an association thresholding layer.

17. The apparatus of claim 12, wherein AD-TCN training is performed using stochastic gradient descent is utilized with adaptive moment estimation as an optimizer which provides iterative optimization for minimizing the loss function during the training of neural networks.

18. The apparatus of claim 12, wherein said indoor occupancy sensing enables many smart building applications to associate between vibration sensing modalities and wearable sensors.

19. The apparatus of claim 18, wherein said smart building applications are selected from a group of smart buildings applications consisting of home, care facilities, hospice, retail stores, and business operations.

20. A method of determining cross-modal association between wearable and structural vibration signal segments for indoor occupant sensing, comprising:
(a) performing multimodal signal alignment module configured for receiving sensor inputs of different modalities as a combination of a structural vibration sensor associated with a physical structure, and a wearable sensor having wearable sensor inputs associated with a user; and in which a sampling rate and timestamps of the sensor inputs are aligned in said multimodal signal alignment module;
(b) detecting infrastructure events and segmenting sensor inputs as segment-level associated cross modalities between the vibration sensor inputs and the wearable sensor inputs within said multimodal signal alignment module;
(c) performing association discovery in a temporal convolutional network (AD-TCN) configured for determining an extent of shared context between signal segments from different modalities, comprising: an association score layer coupled to a plurality of temporal convolution network (TCN) blocks, with each of the plurality of TCN blocks coupled to a pointwise convolution layer which performs infrastructure signal prediction over a period of time and outputs wearable and vibration segment values;
(d) wherein said wearable and vibration segment values are utilized to predict the current time step value of the vibration segment, and train the convolution network to determine association probability between signal segments from these two modalities based on the weights of the trained AD-TCN, wherein association probability reflect contributions of one signal segment for predicting the other signal segment; and
(e) performing a pairwise association determination in which output from the association discovery TCN is used in estimating association probabilities based on determining association distance as a measurement of the association relationship which is then converted to a common measurement between multi-modal sensing, to which association thresholding is performed to generate a pairwise association output indicating whether there is sufficient cross-modal association between the structural vibration sensor associated with a physical structure, and the wearable sensor associated with a given user to consider both sensor inputs to be indicative of the same event.
